(19) United States
(12) Patent Application Publication
(10) Pub. No.: US 2020/0325723 A1
(43) Pub. Date: Oct. 15, 2020

(54) PROCESS FOR MANUFACTURING VACUUM INSULATING GLAZING

(71) Applicant: AGC GLASS EUROPE, Louvain-La-Neuve (BE)

(72) Inventors: Sebastien CALIARO, Moriaime (BE); Francois CLOSSET, Jalhay (BE); Julien JEANFILS, Thorembais-St-Trond (BE)

(73) Assignee: AGC GLASS EUROPE, Louvain-La-Neuve (BE)

(21) Appl. No.: 16/090,709

(22) PCT Filed: Mar. 21, 2017
(86) PCT No.: PCT/EP2017/056699

§ 371 Date: Oct. 2, 2018

(30) Foreign Application Priority Data
Apr. 5, 2016 (EP) 16163886.1

(51) Int. Cl. E06B 3/673; C03C 27/08; E06B 3/66; E06B 3/663; E06B 3/677

(52) U.S. Cl. CPC E06B 3/67334; C03C 27/08; E06B 3/6612; E06B 3/66304; E06B 3/6617; E06B 3/6775; E06B 3/66371; E06B 2003/66395; E06B 3/66357

(57) ABSTRACT

The invention relates to a process for manufacturing a vacuum insulated glazing wherein the glazing is prepared by supplying glass panes, pillars and edge metallic seal elements, said edge metallic seal elements are brazed simultaneously together and with a functional layer previously deposited onto the peripheral zone of the glass panes.

### TECHNICAL DOMAIN OF THE INVENTION

The present invention relates to a process for manufacturing thermally insulating glazing such as vacuum glazing. The present invention also relates to the glazing thus obtained.

### BACKGROUND OF THE INVENTION

In general, vacuum glazing is composed of a minimum of two glass panes separated by a void space with a thickness in the range starting at 100 μm and up to 800 μm. Sealing is obtained by a peripheral seal. To achieve super-insulation performances (coefficient of surface transmission U<0.6 w/m²K), the vacuum level between the glass panes must be in the order of 10⁻³ mbar or less, and generally at least one of the two glass panes must be covered by a low-emissivity layer having an emissivity of ideally less than 0.05.

Different seal technologies exist and each has some disadvantages. A first type of seal (the most widespread) is a seal based on a solder glass, the melting temperature of which is lower than that of the glass of the glazing panes. The use of this type of seal limits the choice of low-emissivity layers to those that are not impaired by the thermal cycle necessary for usage of the welding glass, i.e. to that which is resistant to a temperature that can be up to 350° C. Moreover, since this type of seal based on welding glass has very low deformability, it does not allow absorption of the effects of differential expansions between the glass pane of the glazing on the internal side and the glass pane of the glazing on the external side when these are subjected to substantial differences in temperature (e.g. 40° C.). Quite significant stresses are thus generated on the periphery of the glazing, which can cause breakages of the glass panes of the glazing.

A second type of seal comprises a metal seal, e.g. a metal strip with a low thickness (<500 μm) welded around the periphery of the glazing by means of an attachment sub-layer covered at least partially with a layer of a solderable material such as a tin alloy soft solder. A significant advantage of this second type of seal over the first type of seal is that it can be deformed to absorb the differential expansions created between the two glass panes.

Patent application US 2008/0245011 A1 discloses a method for manufacturing a vacuum insulated double glazing having a peripheral vacuum-tight edge connection by welding together two metal foil strips connected to the peripheral zones of each glass pane's inner glazing face, the strips protruding beyond the edges of the glass panes. Welding is performed by sweeping a laser beam along the protruding parts of the metal foil strips.

Such glazing does not allow edge connections which do not extend outside the periphery of the panes. Additionally, after being welded together, the protruding parts of the foil strips must be bended onto the glass pane edges and mechanical weaknesses may be introduced in the bending areas.

Another disadvantage of the glazing according to US 2008/0245011 A1 is that mechanical stresses may still take place during the welding operation which is performed one zone at a time as the laser beam sweeps along.

Patent application PCT/EP2015/073050 discloses a process for manufacturing a vacuum insulating glazing having a vacuum-tight peripheral seal obtained by brazing corner metallic seal elements, frame metallic seal elements and adhesion layers positioned on the periphery of the glass panes together simultaneously.

Such process is relatively complex and time consuming in the number of different metallic seal elements to be manufactured, placed and brazed in the glazing to form the vacuum-tight peripheral seal.

### SUMMARY OF THE INVENTION

An aspect of the present invention proposes to use a metal type seal, e.g. a metal strip, for vacuum insulating glazing (i.e. for multiple glazing, e.g. double or triple glazing). In fact, it has surprisingly been observed that such a seal allows to guarantee the maintain of a sufficient level of vacuum for the classic service life of vacuum glazing systems (10 years). One advantage of some embodiments of the present invention is good adhesion of the seal to glass panes. Another advantage of some embodiments of the present invention is that they are conducted in a simple manner at reasonable cost.

Other advantages of some embodiments of the present invention are namely:
To allow an efficient and cost competitive manufacturing of made-to-measure frames adapted to various sizes of glazings.
To allow the in situ formation of the frame.
To allow an efficient manufacturing process by minimizing the number of required metallic seal elements.
To allow an efficient manufacturing of the peripheral seal adapted to a wide range of glazing dimensions.

A matching of the thermal expansion coefficients of the seal material and of the glass is no more required for the brazing operations. Still another advantage of some embodiments of the present invention is that it has surprisingly been observed that the pane substrates are not damaged by the process (no cracking observed during optical microscope analysis).

The pressure inside the vacuum glazing is preferably at most 10⁻² mbar, more preferably at most 10⁻³ mbar and is maintained at these levels for a working period of 10 years.

In a first aspect, the present invention aims at avoiding the disadvantages of the prior art by supplying a process for manufacturing a vacuum insulating glazing comprising the steps of:
a) providing a pre-assembly of vacuum insulating glazing components comprising:
   at least two glass panes each of them provided with a functional layer onto a peripheral zone on at least one of their sides,
   at least one pillar located between the glass panes and maintaining them at a certain distance from one another and creating a void space between them,
   at least two edge metallic seal elements located onto the functional layers of the glass panes in the form of a continuous peripheral frame,
b) brazing simultaneously together the at least two edge metallic seal elements and the functional layers of the glass panes to form a peripheral seal ensuring the vacuum tightness of the glazing,
c) unloading the finished glazing,
   wherein the edge metallic seal elements are supplied in a manner that they each overlap the adjacent edge metallic seal element in overlapping areas for a distance not greater than 20 mm and each edge metallic seal element is let to overlap further the adjacent edge metallic seal element by free dilatation during the brazing for forming the peripheral seal, and
   wherein at least one edge of the glazing contains one single overlapping area.

In another aspect, the present invention also relates to the glazing obtained by the process in accordance with the invention.

### DETAILS OF THE INVENTION

The process according to the present invention relates to the manufacturing of a vacuum insulating glazing. By vacuum insulating glazing, we intend to mean a multiple glazing comprising at least two glass panes separated by a void space wherein remaining pressure of gas is preferably at most 10⁻² mbar, more preferably at most 10⁻³ mbar. Additional glass panes can be added that are separated from the 2 first ones similarly by spaces under vacuum and/or by spaces intended to receive an insulating gas filling.

In the first step of the process according to the invention is provided a pre-assembly of vacuum insulating glazing components. By pre-assembly is meant that the components are adequately arranged to form a vacuum insulating glazing, but are not yet definitively fixed together.

The vacuum insulating glazing components comprise at least two glass panes each of them provided on at least one side onto a peripheral zone with a functional layer. The glass can be of any type suitable to manufacture vacuum insulating glazing. Some non-exhaustive examples of such glasses are annealed glass, tempered glass, laminated glass, coated glass.

The functional layer is a layer that has both the function of being able to be brazed and the function of having a good adhesion on glass. By brazing is meant a joining operation between metal elements that uses a brazing material with a melting point below the melting point of the metal elements to be joined. The brazing material will flow in the gaps between the elements and bind them. A surface able to be brazed means here a surface made of a brazing material or compatible with a brazing material.

In a first variant, the functional layer comprises at least one layer providing adhesion to glass and comprising a brazing component. Examples of materials suitable for the functional layer of the first variant is Cerasolzer® or Cerasolzer-Eco®.

In a second variant, the functional layer comprises at least two layers each of them bringing one of the functions.

The layer bringing the adhesion on glass can for instance comprise materials selected amongst copper, aluminum, iron, chromium, platinum, nickel, gold, silver, titanium, tin, and copper-, aluminum-, iron-, chromium-, platinum-, nickel-, gold-, silver-, titanium-, tin-based alloys. Preferred materials are copper, titanium, chromium and copper-, titanium-, chromium-based alloys. The deposition of the adhesive material may be performed by a conventional method of low-velocity flame spraying or by the new method using a HVOF (high-velocity oxy/fuel) spraying method. The latter method has been disclosed in details in the international patent application of AGC Glass Europe WO 2011/061208 A1 incorporated here by reference. The HVOF method of deposition is preferred.

The layer bringing the ability to be brazed can for instance comprise brazing materials selected from tin, lead, copper, silver, indium, bismuth, nickel, zinc, silicium, cadmium, antimony, gold and tin-, lead-, copper-, silver-, indium-, bismuth-, nickel-, zinc-, silicium-, cadmium-, antimony-, gold-based alloys. Preferred are tin, copper, lead, silver and tin-, copper-, lead-, silver-based alloys. The brazing layer can for example be applied in a solid form on the surface as a foil, a wire or a paste. Alternatively, it can be applied on the surface by known tinning processes such as electrolytic deposition, spraying and the like.

A preferred functional layer according to the second variant comprises a layer bringing the adhesion function comprising materials selected from copper, titanium, chromium and copper-, titanium-, chromium-based alloys and a layer bringing the brazing function comprising materials selected from tin, copper, lead, silver and tin-, copper-, lead-, silver-based alloys.

In a third variant, the functional layer comprises at least one layer of copper. Copper brings adhesion to the glass and is compatible with brazing materials. In this case, the brazing material will be either provided as a foil, a wire or a paste or by specific edge metallic seal elements that are coated with a brazing material. Both alternatives will be detailed later.

The functional layers are deposited on peripheral zones of the glass panes. By peripheral zones it is intended a zone of a width ranging from 0.5 cm to 5.0 cm along all edges of the pane at a distance from the edge ranging from 0 to 10 cm. The zone width is preferably at most 3 cm, more preferably at most 1.5 cm and the distance from the pane edges is preferably at most 5 cm, more preferably at most 3 cm.

By extension, the wording “peripheral zone” intends as well to designate the whole surface of the lateral edges of the glass panes extending along the thickness of the glass panes, as it will be illustrated later by the figures.

For making double glazing according to the process of the invention, a functional layer is deposited on one side only of the glass panes. For making multiple glazings comprising at least 3 panes, the two outer panes are deposited with peripheral functional layers on one side only, while the inner panes are deposited on one or both sides with peripheral functional layers, according to the design of the sealing elements. This will be explained later in connection with the examples and the figures.

The vacuum insulating glazing components further comprise at least one pillar located between the glass panes and maintaining them at a certain distance from one another and creating a void space between them.

By pillar, we intend to mean an element having a high resistance to compression ensuring the preservation of a certain distance between the glass panes and avoiding the collapsing under the pressure of the atmosphere surrounding the vacuum insulating glazing. They may be made of various materials of high resistance to compression such as ceramic, glass, metal, composite materials. Metallic pillars, like stainless steel pillars have given good results.

Their number depends on the surface of the glazing ranging from several tens for large sizes through one only or a few units only for small sizes. The pillars are generally arranged at more or less regular intervals between the adjacent panes, and their number is adapted to the surface of the glazing.

In the present invention, at least one pillar is used, preferably a set of pillars is used. The wording “set of pillars” used herein intends to designate a number of pillars, ranging from 2 to a positive integer representing the quantity required to maintain the distance between the glass panes.

In the case of manufacture of a multiple glazing with vacuum between some panes and gas filled space between other glass panes, pillar(s) are only arranged between the panes which will delimit the space under vacuum and not between the panes delimiting spaces intended to receive the gas filling. In the case of a multiple glazing with only spaces under vacuum between the panes, pillar(s) are arranged in all the spaces.

The vacuum insulating glazing components further comprise at least two edge metallic seal elements located onto the functional layers of the at least two glass panes in the form of a continuous peripheral frame. Each edge metallic seal element overlap the adjacent one in an overlapping area and at least one edge of the glazing contains one single overlapping area.

Edge metallic seal elements hereby mean metallic elements forming together a continuous peripheral frame. The continuous peripheral frame is formed of edge metallic seal elements that are composed of two straight portions linked by a corner and/or three straight portions linked by two corners. The edge metallic seal elements comprising two straight portions have a L-type shape. The edge metallic seal elements comprising three straight portions have a U-type shape. The terms L-type and U-type as used herein are in no way limitative to any specific L or U geometry, they are solely used to ease the understanding and will be further illustrated by the figures. The angle at the junction of the straight portions can be any angle suited to fit the glazing corners. Generally, it is an angle of 90°. The sizes of the edge metallic seal elements are chosen on the one hand to allow the formation of a frame fitting onto the functional layers of the glass panes and on the other hand to allow an overlap between adjacent edge metallic seal elements. These sizes of the edge metallic seal elements can be the same or different as long as the two criteria are met.

The edge metallic seal elements are generally made of metallic profiles like, e.g. extruded, folded or stamped profiles. Profiles which have given good results are, for example, folded profiles bent to fit the corners of the glazing. Suitable metals of the edge metallic seal elements are for instance copper, aluminium, stainless steel, and copper- or nickel-based alloys such as Kovar®, Invar®. It is preferable that the same metal or metal alloy grade is chosen for all the seal elements used in a given glazing. The edge metallic seal element may optionally be coated with a brazing material as described supra for the layer bringing the brazing function. An example of such seal elements are tinned edge metallic seal elements. The metal of the edge metallic seal elements is preferably selected from copper and copper based alloys.

The edge metallic seal elements are supplied in a manner that they each overlap the adjacent edge metallic seal element in overlapping areas. The shape of the edge metallic seal elements is designed to allow an overlap between adjacent edge metallic seal elements and hence depends on the geometry of the material used to make the edge metallic seal elements. This will be illustrated later in the Figures. The overlap between adjacent edge metallic seal elements is initially realized for a distance which does not exceed 20 mm, preferably 10 mm, more preferably 5 mm, most preferably 3.5 mm. The edge metallic seal elements may be positioned one by one onto the functional layers with said overlap.

In a particular variant of the invention, the number of edge metallic seal elements is preferably ranging between 2 and an integer equal to the number of edges of the glazing. For instance, for a rectangular or square shape glazing from 2 to 4 edge metallic seal elements will be used.

In another particular variant of the present invention, the continuous frame is made of two edge metallic seal elements of the U-type. This variant is particularly suitable for glazings that do not have a square shape and that present smaller and longer edges such as a rectangle for instance. In this case, overlapping areas between adjacent seal elements are present on the longest edges of the glazing only. They will absorb the dilatation occurring during the brazing of the straight portions of the edge metallic seal elements present on these edges. On the other hand, the straight portions of the edge metallic seal elements located on the smallest sides of the glazing have a length small enough to avoid expansion outside of the peripheral zone without the need of overlapping areas.

In yet another particular variant of the present invention, the continuous frame is made of four edge metallic seal elements of the L-type.

In still another particular variant of the present invention, the continuous peripheral frame further comprises linear edge metallic seal elements that can be inserted between the other edge metallic seal elements. In this case again, at least one edge of the glazing has to contain one single overlapping area. In these conditions, contrarily to the patent application PCT/EP2015/073050 some or all the straight frame metallic seal element are avoided between corner metallic seal elements to form the peripheral continuous frame. The present process improves the manufacturing efficiency by minimizing the number of required metallic seal elements.

The vacuum insulating glazing components can be pre-assembled in any suitable manner known to the skilled person.

In the second step of the invention, the edge metallic seal elements and the functional layers are brazed together simultaneously. The brazed edge metallic seal elements and functional layers form the peripheral seal. By peripheral seal is meant here the continuous peripheral element formed by the brazing of the edge metallic seal elements together and with the functional layers conferring the vacuum tightness to the glazing.

In a particular variant of the invention, brazing is performed simultaneously between tinned edge metallic seal elements and the functional layers of the glass panes each comprising a layer bringing adhesion on glass comprising materials selected from copper, titanium, chromium and copper-, titanium-, chromium-based alloys and a layer bringing the ability to be brazed comprising materials selected from tin, copper, lead, silver and tin-, copper-, lead-, silver-based alloys. Additional brazing paste could optionally be added at the overlapping areas of the edge metallic seal elements before the assembling step in order to strengthen the glazing tightness.

Brazing operations in the process according to the invention are performed at a temperature of at least 150° C., preferably at least 180° C., more preferably at least 200° C. The brazing temperature is at most 450° C., preferably at most 350° C., more preferably at most 300° C. During the brazing action of the second step, each edge metallic seal element is let to overlap further the adjacent edge metallic seal element by free dilatation due to heating. By free dilatation is here meant that the edge metallic seal elements are free to move relatively to each other due to their dilatation upon heating. At the end of the brazing action, said overlaps can reach a distance up to 4 cm. The seal elements dilatation is absorbed by an increasing overlap between them during the brazing action. As a result, the total frame expansion is advantageously significantly reduced even if the thermal dilatation of the seal elements is important. This effect is obtained thanks to the fact that brazing of the edge metallic seal elements together and with the functional layers are performed simultaneously. In consequence, the present process allows the manufacturing of large size glazings without the problems generally associated with the expansion of a large size frame such as mechanical issues (glass cracks or scales) or design constraints with regards to the peripheral seal width. The second step of the process also allows the in situ formation of the frame. It allows avoiding the manufacturing of the frame in advance, what is advantageous in terms of process efficiency.

The process according to the invention is able to deliver glazings which ensure a vacuum tightness between the panes. As explained above, the remaining pressure of gas between the panes is at most 10⁻² mbar, more preferably at most 10⁻³ mbar. Additionally, the process according to the invention is able to guarantee the maintenance of a sufficient level of vacuum, i.e. at most 10⁻² mbar, for the classic service life of the vacuum glazing systems (10 years, in general). The process according to the invention is able to reach that vacuum performance thanks to the realisation of the peripheral seal along all the edges of the panes.

There is further a third step in the process according to the invention which consists of the unloading of the finished glazing. That last step comprises the removal of the manufactured glazing from the area of processing and its transport to a storage area.

The steps of the present invention are preferably performed in the mentioned order.

Other optional steps may take place in the process according to the present invention.

An optional step applicable to all the variants of the invention is the introduction of additional brazing material on at least one functional layer and/or on the edge metallic seal elements. The brazing material is preferably supplied as a foil, a wire or a paste. This step is performed during the step of pre-assembly and before the step of brazing.

In another optional step applicable to all the variants of the present invention, the edge metallic seal elements are temporarily assembled in a frame with the initial overlap as previously described. The temporary assembly is performed thanks to an assembly material sensitive to heat. Upon heating during the brazing operation, the heat sensitive material will release the edge metallic seal elements to allow their free dilatation to be absorbed by a supplemental overlap between them. Examples of suitable materials are low melting temperature materials such as alloys made of bismuth, lead and tin. The temporary assembly step can be performed at any moment before the positioning of the edge metallic seal elements onto the functional layers of each glass pane. This optional step advantageously allows to ease the positioning of the edge metallic seal elements in the pre-assembly and hence improves the process efficiency.

In a particular variant of the present invention applicable to all the variants of the invention, the mobility of the corner area of the edge metallic seal elements is limited while the straight portions areas are free to move upon heating. In this variant, the total frame expansion is further reduced and is close to zero, preferably, it is equal to zero. The mobility of the corner areas of the edge metallic seal elements may be limited for instance by mechanical means such as pressure or a stop element.

According to an embodiment of the process in accordance with the invention, the brazing step of the process may advantageously be performed in a vacuum chamber. The pre-assembly step could also be partially or totally done in the vacuum chamber. That embodiment is particularly preferred in situations where the implementation of a continuous process is contemplated. Vacuum level inside the chamber may be constant during the whole duration of the said steps and at least equal to the high level aimed inside the void space(s) of the multiple glazing that will be manufactured. Alternatively, the residual pressure inside the chamber may be slightly higher than the low level of pressure required inside the void space(s) of the finished multiple glazing and may be boosted during the brazing step only, just before the sealing of the glazing.

According to an alternative embodiment of the process in accordance to the invention, the process may be performed at atmospheric pressure and a supplemental step of soldering at least one closable metallic tube on the peripheral seal is realized, and through which atmospheric air is then pumped out to reach vacuum between the glass panes. Atmospheric air elimination is required after the brazing step. This embodiment is more suited to discontinuous processes. It is realized generally by soldering at least one tube on the peripheral seal, e.g. a metallic tube, which establishes a communication between the inner space of the glazing and the atmosphere. The elimination of air can be done after by pumping it out. The tube is then closed when the aimed level of vacuum is reached.

According to another embodiment of the process in accordance with the invention, compatible with all the other embodiments, during the brazing operations, heat is supplied from the edge metallic seal elements themselves. The edge metallic seal elements are preferably heated by induction heating. That technique is able to supply highly controllable and reproducible results. Moreover, brazing by induction heating can achieve very quick and localized heating, easily and precisely focused on the region which is to be heated, without exceeding the aimed temperature. Brazing by induction allows hence an efficient manufacturing of the peripheral seal adapted to various sizes of glazings. Typical heating time of heating the seal elements by induction is no longer than 5 minutes and, preferably no longer than 3 minutes. Most preferably, heating time of the seal elements is no longer than 2 minutes. Localized heating means here a heating of the edge metallic seal elements along all the edges of the panes without the requirement of heating also the glass panes. A matching of the thermal expansion coefficients of the seal material and the glass is no more required by the brazing operations. Brazing operations by induction are performed at a temperature of at least 150° C., preferably at least 180° C., more preferably at least 200° C. The temperature is at most 450° C., preferably at most 350° C., more preferably at most 300° C. Temperatures which are the most preferred for the brazing operations are from 200° C. up to 300° C.

In the process in accordance with the invention, according to another embodiment compatible with all the preceding ones, all the glass panes have the same dimensions.

Alternatively, according another embodiment compatible with all the other embodiments, except the preceding one, the glass pane at the base of the stack has the greatest dimensions and the dimensions of each glass pane on top of that base pane are lower than the dimensions of the pane directly adjacent beneath. The resulting stack forms a kind of stepped pyramid.

Independently from the dimension embodiments of the panes, in the process according to the invention, the edge metallic seal elements may or not extend outside the surface edges of the glass panes. When they extend outside the surface edges of the glass panes, the edge seal elements may enfold the entire stack borders. When they do not extend outside the surface edges of the panes, the edge metallic seal elements may be located inside the area delimited by the edges of the glass panes, in a region not far from those edges.

In the particular case when all the panes have the same dimensions and the edge metallic seal elements do not extend outside the surface edges of the glass panes, the edge elements may be flush with the edges of the glass pane and the finished glazing.

Another particular case is when all the panes have the same dimensions and the edge elements are brazed onto the edges of the glass panes.

The present invention relates as well to the glazing obtained by any of the embodiments of the process in accordance with the invention. The glazing obtained advantageously allows narrow tolerances on the peripheral seal design and thus narrow peripheral seal width could be targeted, for instance as narrow as 20 mm and lower. For a given window frame, a smaller peripheral seal width generally leads to a lower thermal transmittance of the window (U_{w}) by minimizing the thermal losses by conductibility of the glazing edges.

### BRIEF DESCRIPTION OF THE FIGURES

FIG. 1 illustrates a view in plan of a double glazing obtained according to a variant of the process of the invention wherein the continuous frame is formed of four edge metallic seal elements (10) having a L-type shape. The edge metallic seal elements (10) overlap each other in overlapping areas (11). Represented as well are the pillars (8).

FIG. 2 illustrates a view in plan of another double glazing obtained according to a variant of the process of the invention wherein the continuous frame is again formed of four edge metallic seal elements (10) having a L-type shape. The straight portions of the edge metallic seal elements (10) have different relative lengths compared to FIG. 1. Represented as well are the pillars (8) and the overlapping areas (11).

FIG. 3 illustrates a view in plan of a double glazing obtained according to another variant of the process of the invention wherein the continuous frame is formed of two edge metallic seal elements (10) having a U-type shape. The edge metallic elements (10) overlap each other in overlapping areas (11) located on the longest edges of the glazing. Represented as well are the pillars (8).

FIG. 4 illustrates a view in plan of another double glazing obtained according to a variant of the process of the invention wherein the continuous frame is again formed of two edge metallic seal elements (10) having a U-type shape. The straight portions of the edge metallic seal elements (10) have different relative lengths compared to FIG. 3. Represented as well are the pillars (8) and the overlapping areas (11).

FIG. 5 illustrates a view according to section A-A′ of FIG. 4. It shows an example of suitable shape of the edge metallic seal elements to allow an overlap between the straight portions of adjacent edge metallic seal elements.

FIG. 6 illustrates a view according to section A-A′ of FIG. 4. It shows another example of suitable shape of the edge metallic seal elements to allow an overlap between the straight portions of adjacent edge metallic seal elements.

FIG. 7 shows a section of a double vacuum insulated glazing obtained according to the process of the invention wherein the glass panes (5) have not the same dimensions. Represented are the metal peripheral seal (1), a brazing material (2), the functional layer (3) and the void space (4).

FIG. 8 shows a section of a triple vacuum insulated glazing obtained according to the process of the invention wherein the glass panes (5) have not the same dimensions and wherein references (1), (2), (3) and (4) have the same meaning as the ones from FIG. 3.

FIG. 9 is a section of a double vacuum insulated glazing obtained according to the process of the invention just before and after brazing the edge metallic seal elements (10) to form the peripheral seal (1) wherein both glass panes have the same dimensions and the edge metallic seal elements (10) enfold the entire stack border. Represented as well is the functional layer (3) and brazing material (2) before and after brazing.

FIG. 10 is a section of a double vacuum insulated glazing obtained according to the process of the invention wherein both glass panes have the same dimensions and the peripheral seal (1) is located inside the area delimited by the edges of the glass panes and is flush with those edges.

FIG. 11 illustrates a particular case wherein both glass panes have the same dimensions and the peripheral seal (1) is brazed onto the lateral edges of the glass panes.

FIG. 12 is a section of a double glazing which is a variant of the one of FIG. 6 wherein the peripheral seal (1) is as well located inside the area delimited by the edges of the glass panes but is not flush with the edges.

### EXAMPLES

### 1. Reference Example (Not According to the Invention)

According to previous art (description done in the patent application of AGC Glass Europe WO 2011/061208 A1), a double vacuum glazing is processed with two different dimensions of 6 mm thick glass panes (572 mm*572 mm and 594 mm*594 mm). In order to reach low U-value (below 0.6 W/(m².K)), a low-emissivity coated glass is chosen for the small pane. A functional layer made of an adhesion layer and a brazing layer is applied. A first adhesion layer of pure copper is deposited by metal spraying (HVOF) on whole glasses periphery. The mean thickness of this layer is 30 μm. The adhesion layer width is 10 mm and the distance of the adhesion layer from the glass edge is less than 1 mm. A brazing layer of Sn₆₀Pb₄₀ alloy is then deposited manually on the first copper layer thanks to a soldering iron. The soldering iron temperature range is maintained between 300° C. and 350° C. and is measured thanks to a type-K thermocouple. The measured thickness of this layer is 300 μm in average. The measurements are done randomly with a caliper all along the edges. Despite some thickness non-homogeneities due to the manual operations, the two layers are continuous all around the periphery of both the glass panes. Small metallic pillars (small stainless steel cylinders of 500 μm diameter) are placed regularly each 5 cm on the largest glass pane. This operation is performed manually using tweezers. A tinned copper frame and the second glass pane are then placed on the largest glass pane, on top of the steel pillars. The copper frame had previously been produced as follows.

Copper frame assembling: Stamped corner pieces and folded straight pieces are welded together by laser welding. After welding the junctions of the copper pieces, the obtained squared frame (574 mm*574 mm) is tinned (10 μm of tin deposited by electrolysis). The frame obtained has a Z-shape section in order to be able joining the functional layers of the two glass panes (like the one of FIG. 7).

Brazing is performed by induction. The whole seal (zone edges of the first pane, the copper frame and zone edges of the second pane) are placed in the vicinity of a copper induction ring. Eddy currents are generated during 1 min in the copper frame and they heat the seal up to 300° C. The temperature is measured thanks to an IR pyrometer placed near one corner of the glazing. During the process, all seal components (the functional layers and the tinned copper frame) are pressed together and thus maintained in close contact. The SnPb alloy on the glass panes and the tin on the frame are re-melted during this step and create a tight brazed seal all around the glazing. The average brazing width is 5 mm. Due to the relatively high thermal expansion of the copper frame during that process, the measured copper frame dimensions after assembling has increased of 3 mm in xy directions. In the chosen configuration, the treatment was large enough on glass periphery to guaranty a tight seal join. It is of course mandatory that a sufficient part of the frame (5 mm) stays located on the tinned glass edges during and after the heating. Generally, the seal width has to be lower or equal to 20 mm in order to integrate it in a commercial window frame. In this case, due to process tolerances and thermal expansion encountered by the frame, some part of it are very close to the glass edges. Based on the observed geometry, keeping 20 mm seal width will not be possible for large glazing dimensions (for a 3 m length dimension, the copper frame expansion will be of 15 mm and will thus expand beyond the tinned glass edges). A tube is then brazed on the seal and is used to pump out the glazing before closing it off. Before closing off this tube, the seal tightness is evaluated with helium leak detector. No leakage is observed. After pumping the glazing and closing off the tube, the evaluated thermal transmittance of the glazing is 0.5 W/(m².K). The evaluation is done based on the method described in the EN674 standard (Glass in building.—Determination of thermal transmittance (U value)).

### 2. Example 1 (According to the Invention)

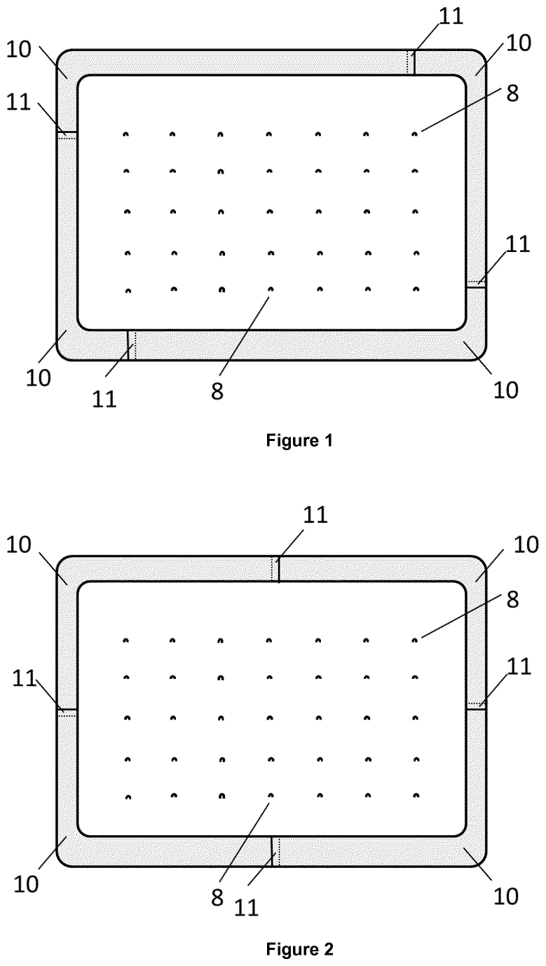

Similarly to the reference example description, an adhesion and a brazing layers are applied on the glass panes. Dimensions of the panes are similar to the ones of the reference example. According to the invention, the edge metallic seal elements which are placed on the glass panes before assembling the whole glazing are made of 4 copper pieces (according to the FIG. 2). The overlapping areas of the four elements are located at the middle of each glass pane edge. Brazing is performed by induction using Eddy currents as described in the reference example. During induction heating, the edge metallic seal elements are free to move relatively to each other thanks to the overlapping areas (pieces were not pre-welded together as done in the reference example). The different edge metallic seal elements are thus free to expand on each edge and to overlap each other further during the assembling process. The frame expansion and effect of the overlapping is observed with an high speed camera. The total frame dimension is increased by 1 mm only (3 times less than encountered with the reference example). The main advantage of the invention is to combine smaller seal width with larger glazing dimensions. For a targeted glazing dimension, the process according to the invention allows reducing the peripheral seal width and/or reducing the complexity of the process (larger tolerances could be used during the frame positioning, the number of frame pieces). In the present example, the measured U-value of the glazing is unchanged compared to the reference example. For a given window frame, a smaller seal width will generally lead to a lower thermal transmittance of the window (by minimising thermal losses by conductibility of the glazing edges).

### 3. Example 2 (According to the Invention)

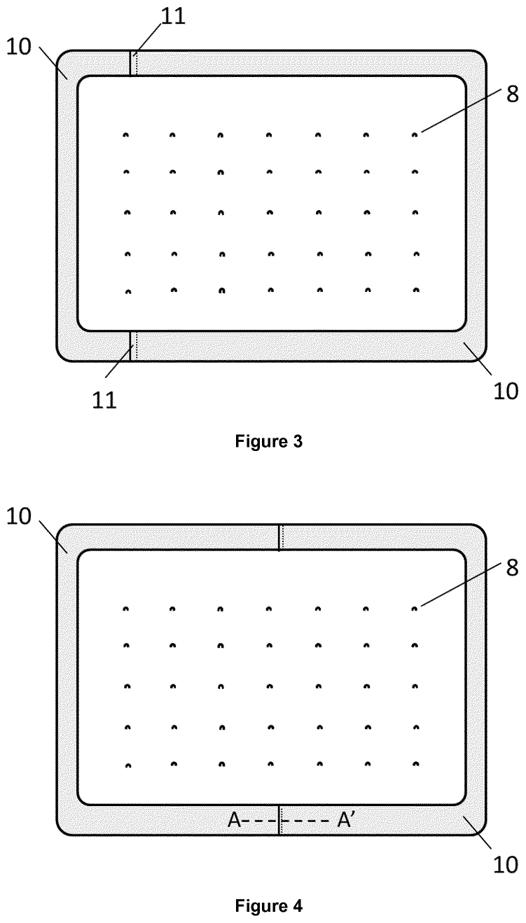

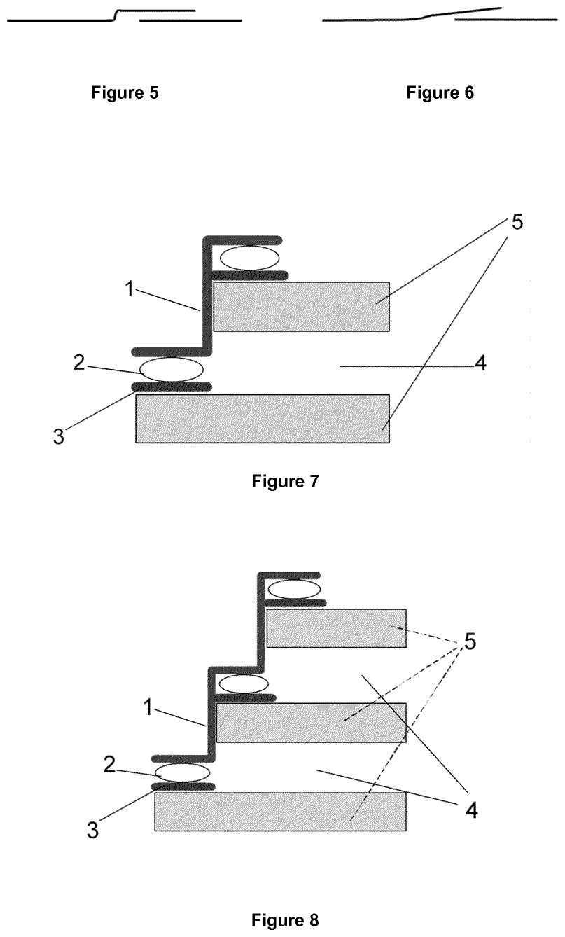

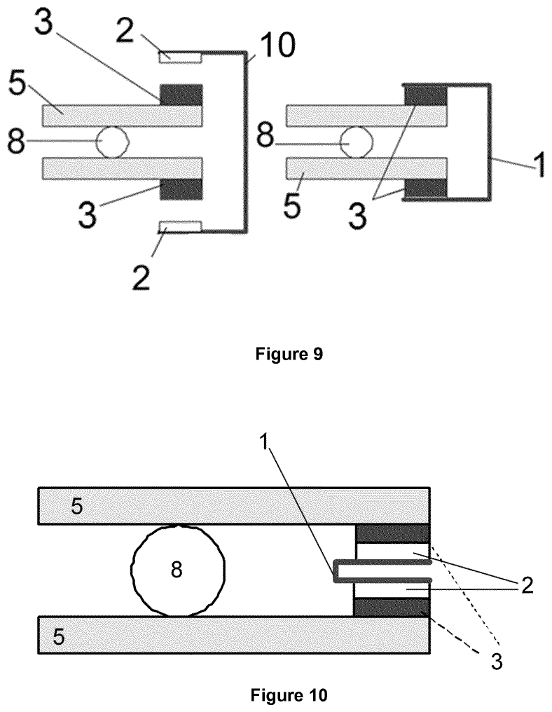

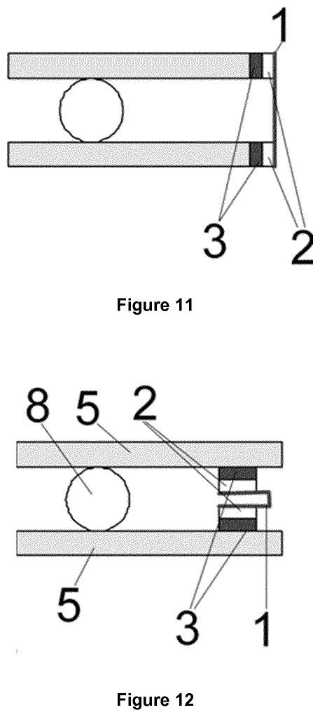

A rectangular glazing (dimensions 300 mm by 600 mm) is produced with two edge metallic seal elements presenting a U-shape. The two overlapping areas are located on the longest edges of the glazing, i.e. the 600 mm edges (according to FIG. 3). Brazing is again performed by induction using Eddy currents as previously described. A higher pressure is applied on the corner areas of the edge metallic seal elements during induction heating. Each edge metallic seal elements expands of 1.5 mm at each overlapping area so that the total overlapping length is increased by 3 mm at each overlapping area (2 edge metallic seal elements expand each of 1.5 mm at each overlapping area). The overlapping areas absorb these dilatations and thanks to the relative fixed positions of the corner areas, the final frame dimension on the longest edges of the glazing (i.e. 600 mm edges of the glazing) is no more impacted. Even if the dilatation of the edge metallic seal elements is important (proportional to the glazing dimensions), it is absorbed in the overlapping areas and it does not impact the peripheral seal width. Same trial is successfully done on 300 mm by 600 mm glazing with a narrower peripheral seal width of 12 mm (compared to a 20 mm seal width used for previous examples).

1. A process for manufacturing a vacuum insulating glazing, comprising:
a) providing a pre-assembly of vacuum insulating glazing components comprising:
at least two glass panes each provided with a functional layer on a peripheral zone on at least one of their sides,
at least one pillar located between the glass panes and maintaining them at a certain distance from one another and creating a void space between them, and
at least two edge metallic seal elements located on the functional layer of the glass panes in the form of a continuous peripheral frame,
b) brazing simultaneously together the at least two edge metallic seal elements and the functional layers of the glass panes to form a peripheral seal ensuring vacuum tightness of the glazing, and
c) unloading the finished glazing,
wherein the edge metallic seal elements are supplied in such a manner that they each overlap the adjacent edge metallic seal element in overlapping areas for a distance no greater than 20 mm and each edge metallic seal element further overlaps the adjacent edge metallic seal element by free dilatation during the brazing for forming the peripheral seal, and
wherein at least one edge of the glazing comprises one single overlapping area.

2. The process according to claim 1, wherein the brazing b) is performed in a vacuum chamber.

3. The process according to claim 1, wherein the brazing b) is performed at atmospheric pressure, and the process further comprises soldering at least one closable metallic tube on the peripheral seal through which atmospheric air is then pumped out to reach vacuum between the glass panes.

4. The process according to claim 1, wherein the metal of the edge metallic seal elements is selected from the group consisting of copper and copper based alloys.

5. The process according to claim 1, wherein during the brazing operation, heat is supplied from the edge metallic seal elements.

6. The process according to claim 5, wherein the edge metallic seal elements are heated by induction heating.

7. The process according to claim 6, wherein the whole heating time is no longer than 5 minutes.

8. The process according to claim 1, wherein the brazing operation is performed at a temperature from 150 up to 450° C.

9. The process according to claim 1, wherein all the glass panes have the same dimensions.

10. The process according to claim 1, wherein the glass pane at the base of the stack has the greatest dimensions and the dimensions of each glass pane on top of that base pane are lower than the dimensions of the pane directly adjacent beneath.

11. The process according to claim 1, wherein the edge metallic seal elements do not extend outside the surface edges of the glass panes.

12. The process according to claim 9, wherein the edge metallic seal elements are flush with the edges of the glass pane and the glazing.

13. The process according to claim 1, wherein the edge metallic seal elements extend outside the surface edges of the glass panes and enfold the entire stack borders.

14. Glazing obtained by the process according to claim 1.
